(19) United States
(12) Patent Application Publication
(10) Pub. No.: US 2002/0067350 A1
(43) Pub. Date: Jun. 6, 2002

(54) Wireless handwriting input device using graffitis and bluetooth

(76) Inventor: Mourad Ben Ayed, Toronto (CA)

Correspondence Address: MOURAD BEN AYED, 171 ERSKINE AVE #201, TORONTO, ON, M4P 1Y8, CA

(21) Appl. No.: 09/729,968

(22) Filed: Dec. 6, 2000

(51) Int. Cl. G09G 5/00

(52) U.S. Cl. 345/179

(57) ABSTRACT

Wireless input device apparatus allows a user to input data into cellular phones, personal digital assistant, TVs and computers.

The user holds a wireless stylus and performs movements corresponding to graffiti. In the preferred embodiment, graffiti refers to PalmPilot graffiti. The wireless stylus identifies the user symbols and wirelessly sends them to a terminal device. In the preferred embodiment, the wireless stylus uses a BlueTooth transmitter for connecting and sending data to terminal devices, thus, the wireless stylus can be used for inputting data into any BlueTooth compliant system.

In another embodiment, the wireless stylus sends the raw accelerometer data to a terminal device, which identifies the user symbols.

### FIELD OF THE INVENTION

This invention is directed to the field of appliances and more specifically, handwriting-input devices.

### BACKROUNG OF THE INVENTION

Conventional devices for inputting characters into electronic devices involve keyboards, voice synthesizers and stylus. A stylus is a plastic or metal stick used to write on a flat sensitive pad.

U.S. Pat. No. 5,517,579 (“Baron, et. Al.”), discloses a “Handwriting Input Apparatus for Handwriting Recognition Using more than one Sensing Technique”. The apparatus uses an electronic pen containing an accelerometer, and another sensing technique, in order to decipher handwriting. The device is complex, necessitates several components and wires.

U.S. Pat. No. 5,627,348 (“Berkson, et. Al.”) titled “Electronic Stylus with Writing Feel” uses a non marking writing instrument (stylus) and a sensitive writing surface that senses the stylus. This system is a two-part system.

U.S. Pat. No. 6,097,374 (“Howard, et. Al.) titled “Wrist Pendent Wireless Optical Keyboard” describes a system for sensing the presence or absence of human digit or a prosthetic appendage of a wrist. This system is complex not convenient as an input device.

U.S. Pat. No. 5,615,132 (“Horton, et. Al.”) describes a “Method and Apparatus for Determining Position and Orientation of a Moveable Object using Accelerometers”. This patent describes the application of accelerometers to simulation and games but does not describe its applicability to hand writing recognition.

U.S. Pat. No. 5,851,193 (“Arikka, et. Al.”) describes a “Method and Device for the Simultaneous Analysis of Ambulatorily Recorded Movements of an Individual's Different Body Parts”. This patent does not cover the application of accelerometers to hand writing recognition.

The previous systems present a number of disadvantages:

Bulky systems: all previous systems consist of 2 or more sub-systems

Not easy to integrate: none of the previous devices can be easily integrated with a cellular phone or a personal digital assistant

Reliability: most of the previous systems are not reliable in deciphering handwriting

Cost: most of the previous systems are complex, thus costly.

Thus there is a need for a more convenient and reliable method and apparatus for inputting handwriting into any device cheaply and reliably. The device consists of:

One electronic stylus entity that contains one or more accelerometers,

The electronic stylus is used to perform gestures in the air that correspond to graffiti,

The electronic stylus correlates output from accelerometers to graffiti symbol, this task can also be performed at the receiving terminal,

The electronic stylus correlates each graffiti symbol to a letter, number or other symbol,

The electronic stylus uses BlueTooth to send information to any BlueTooth compatible device.

### SUMMARY OF INVENTION

A method for input of handwriting, comprising:

holding a wireless electronic stylus;

pushing a button;

performing movements in the air that correspond to graffiti symbols.

Apparatus for input of handwriting, comprising:

a wireless stylus fitted with accelerometers and a transmitter.

### BRIEF DESCRIPTION OF THE DRAWINGS

The present invention will be more clearly understood after reference to the following detailed specifications read in conjunction with the drawings wherein:

FIG. 1 is a schematic of an electronic stylus;

FIG. 2 is a block diagram of an electronic stylus;

FIG. 3 is a flowchart illustrating the steps involved in capturing handwriting using an electronic stylus;

FIG. 4 is a flowchart illustrating an alternative set of steps involved in capturing handwriting using an electronic stylus;

Similar reference numerals are used in different figures to denote similar components.

### DETAILED DESCRIPTION OF THE PREFERRED EMBODIMENTS

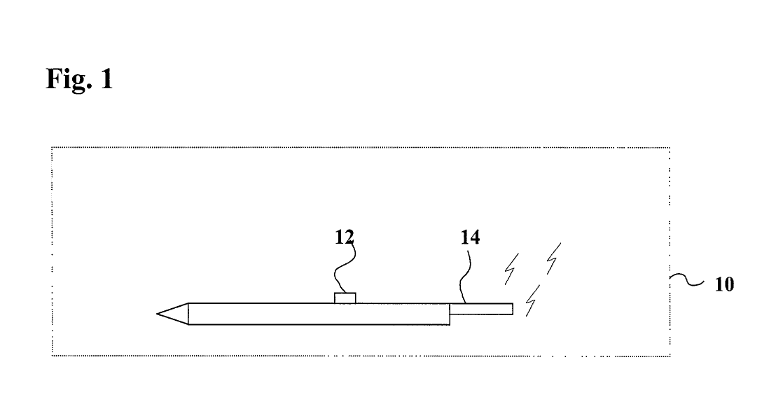

FIG. 1 is schematic of an electronic stylus 10 comprising an activation button 12 and an antenna 14. To start writing, the user pushes button 12 and draws graffiti in the air. (Graffiti is a symbol set that is similar to the alphabet, but that is easier for machines to interpret. An example of graffiti is the one used by PalmPilot personal digital assistants). The graffiti are automatically analyzed, and symbols are displayed on the receiving device.

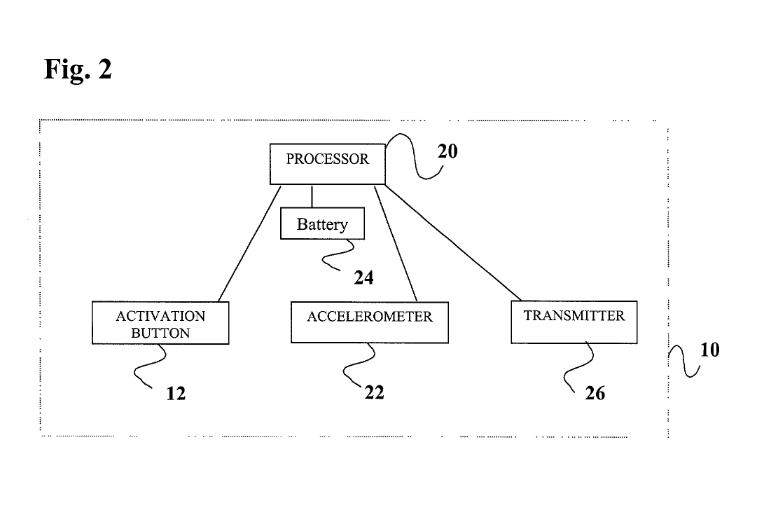

Referring now to FIG. 2, in one embodiment, electronic stylus 10 comprises a processor 20 interconnected with an activation button 12, an accelerometer 22, transmitter 26 and a battery 24.

Processor 20 awaits activation indication from activation button 12, collects data from accelerometer 22, performs correlation, triggers transmitter 26.

Accelerometer 22 can be composed of one or many orthogonally disposed accelerometers.

It will be understood that transmitter 26 may be any type of transmitter capable of transmitting the signals generated by processor 20. Transmitter 26 may be a BlueTooth chip in the preferred embodiment, or a radio frequency (RF), ultrasound, or any other type of transmitter.

When electronic stylus 10 is not in operation it remains in dormant state (“sleep-mode”) to conserve the energy of battery 24.

Battery 24 provides power to some of the components of electronic stylus 10. It will be understood that battery 24 may be nickel-cadmium, lithium, alkaline or nickel-hydride battery or any other portable source of electric power. Battery 24 can also be replaced with photovoltaic cells.

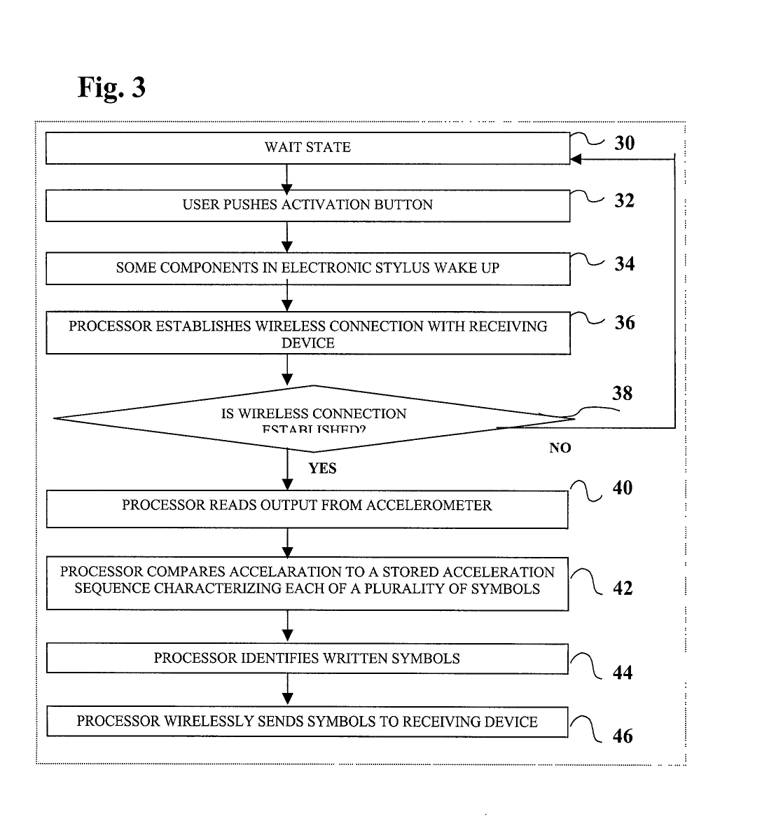

Turning now to FIG. 3, the flowchart illustrates the steps involved in identifying handwriting symbols using an electronic stylus. Upon receipt of a user indication through activation button 12 in step 32, some components of the wireless stylus wake up in step 34 and processor 20 tries to establish a wireless connection with a receiving device in step 36. If a connection cannot be established, the wireless stylus goes to sleep, otherwise, processor 20 reads output from accelerometer 22 in step 40. In step 42, processor 20 compares acceleration parameters from accelerometer 22 with a stored acceleration sequence characterizing each of a plurality of symbols in graffiti. Graffiti is a set of simplified symbols that is similar to the alphabet but that is easier for machines to interpret. In the preferred embodiment, Palm graffiti is used. Next, processor 20 correlates graffiti symbols to letters, number and symbols and identifies written symbols in step 44. Finally, processor 2 sends the symbols to the receiving device using transmitter 26 and antenna 14 in step 46.

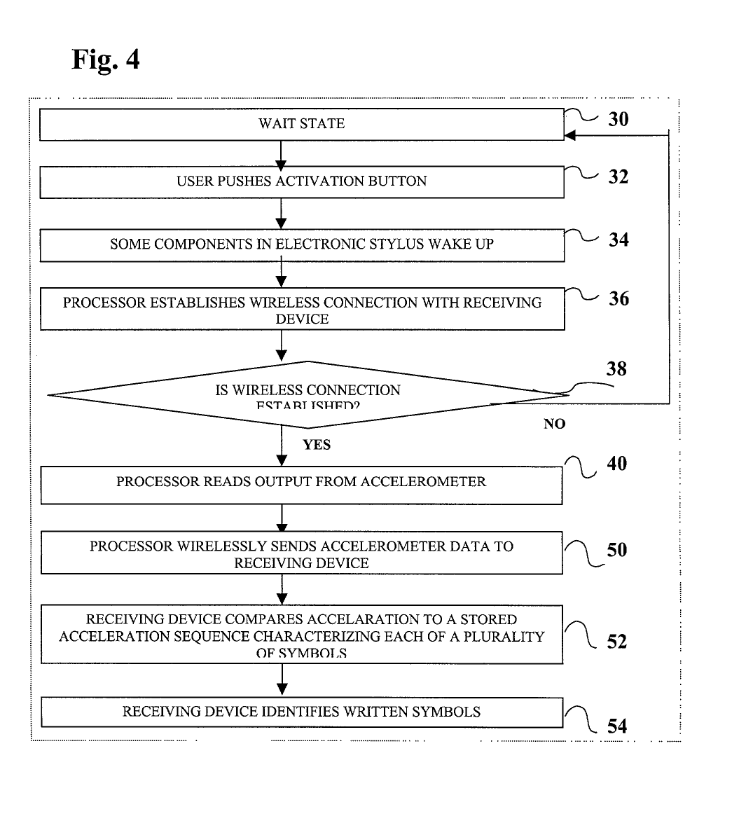

Turning now to FIG. 4, the flowchart illustrates an alternative set of steps involved in identifying handwriting symbols using an electronic stylus. Upon receipt of a user indication through activation button 12 in step 32, some components of the wireless stylus wake up in step 34 and processor 20 tries to establish a wireless connection with a receiving device in step 36. If a connection cannot be established, the wireless stylus goes to sleep, otherwise, processor 20 reads output from accelerometer 22 in step 40. In step 50, processor 20 wirelessly sends data from accelerometer 22 to receiving device. In step 52, the receiving device compares acceleration to a stored acceleration sequence characterizing each of a plurality of graffiti symbols. Processor 20 correlates graffiti symbols to letters, numbers and symbols. Finally, in step 54, the receiving device identifies the written symbols.

Numerous other modifications, variations, and adaptations may be made to the particular embodiment of the invention described above without departing from the scope of the invention, which is defined in the claims.

What is claimed is:

1. A method for input of handwriting, comprising:
holding a wireless electronic stylus;
pushing a button;
performing movements in the air that correspond to graffiti symbols.

2. The method of claim 1 where said electronic stylus performs the followings:
establish a wireless connection with a receiving device.

3. The method of claim 2 further comprising:
getting output from accelerometer,

4. The method of claim 3 further comprising:
getting acceleration sequences characterizing each of a plurality of graffiti symbols from memory;
correlating accelerometer output to said acceleration sequences;
identifying graffiti symbols.

5. The method of claim 4 further comprising:
correlating graffiti symbols to letters.

6. The method of claim 5 further comprising:
correlating graffiti symbols to numbers.

7. The method of claim 4 further comprising:
correlating graffiti symbols to symbols.

8. The method of claim 5 further comprising:
wirelessly sending identified symbols to said receiving device.

9. The method of claim 8 further comprising:
displaying identified symbols.

10. The method of claim 3 further comprising:
wirelessly sending said accelerometer output to said receiving device.

11. The method of claim 10 further comprising said receiving device doing the following:
getting acceleration sequences characterizing each of a plurality of graffiti symbols from memory;
correlating accelerometer output to said acceleration sequences;
identifying graffiti symbols;

12. The method of claim 11 further comprising:
Correlating graffiti symbols to letters.

13. The method of claim 12 further comprising:
Correlating graffiti symbols to numbers.

14. The method of claim 3 where graffiti corresponds to PalmPilot graffiti set.

15. Apparatus for input of handwriting, comprising:
a wireless stylus fitted with accelerometers and a transmitter.

16. The apparatus of claim 15 containing a database of acceleration sequences
characterizing each of a plurality of graffiti symbols.

17. The apparatus of claim 16 wherein said transmitter is a BlueTooth transmitter.

18. The apparatus of claim 17 wherein said graffiti set is the PalmPilot graffiti set.
